(19) United States
(12) Patent Application Publication
(10) Pub. No.: US 2009/0297716 A1
(43) Pub. Date: Dec. 3, 2009

(54) Ink set, and ink jet recording method using the ink set

(75) Inventors: Shuichi Koganehira, Matsumoto-shi (JP); Akira Mizutani, Matsumoto-shi (JP); Hironori Sato, Shiojiri-Shi (JP); Masashi Kamibayashi, Matsumoto-shi (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Seiko Epson Corporation, Tokyo (JP)

(21) Appl. No.: 12/454,303

(22) Filed: May 14, 2009

(30) Foreign Application Priority Data
May 14, 2008 (JP) 2008-127541
May 13, 2009 (JP) 2009-116628

(51) Int. Cl. C09D 11/02; C09D 11/10; B05D 5/00

(52) U.S. Cl. 427/288; 106/31.6; 524/588; 427/256

(57) ABSTRACT

There is provided an ink set with which agglomeration of ink is suppressed, images free from white streaks or roughness can be provided even when printed at a low resolution, and good images, in particular, images having a good hue can be provided.

An ink set is used for an ink jet recording method, the ink set at least including an yellow ink composition, a magenta ink composition, and a cyan ink composition, wherein each ink composition at least contains a pigment, water, a water-soluble alcohol solvent, a slightly water-soluble alcohol solvent, and a surfactant; and the magenta ink composition contains, as the pigment, a solid solution between C.I. Pigment Red 202 and γ-type C.I. Pigment Violet 19.

### CROSS-REFERENCES TO RELATED APPLICATIONS

The entire disclosure of Japanese Patent Application No. 2008-127541, filed on May 14, 2008, and No. 2009-116628, filed on May 13, 2009, are expressly incorporated by reference herein.

### FIELD OF THE INVENTION

The present invention relates to an ink set at least including a yellow ink composition, a magenta ink composition, and a cyan ink composition; and an ink jet recording method in which printing is conducted by making ink compositions adhere to a recording medium.

### BACKGROUND OF THE INVENTION

With the widespread use of techniques for forming images from digital data in recent years, desktop publishing (DTP) is becoming common particularly in the field of printing. When printing is conducted by DTP, a color proof is also produced in advance for checking the gloss or the colors of an actual printed product. Such a proof is output by an ink jet recording method. DTP requires color reproducibility and stable reproducibility in printed products. For this reason, special paper for ink jet recording is generally used as a recording medium for outputting proofs.

Such special papers for ink jet recording are produced so as to reproduce the same gloss and colors as in output products that are actual printed products with coated printing papers. In this way, the materials of special papers are appropriately selected in accordance with the types of coated printing papers. However, production of special papers in accordance with diverse coated printing papers increases the production costs. For this reason, in color proofing applications, there is a demand for ink jet recording with coated printing paper rather than with special paper. When a final proof can be produced by conducting ink jet recording directly with coated printing paper without using special paper, it is thought that costs incurred for proofing can be considerably reduced. Synthetic paper produced by mixing a polyethylene resin or a polyester resin with inorganic filler or the like and forming films with the resultant mixture has been attracting attention as a material having excellent recyclability and environmental friendliness in recent years.

Coated printing paper is coated paper having a coated layer thereon for receiving oil-based ink. The coated layer has a characteristic of poor capability of absorbing ink. For this reason, when commonly-used water-based pigmented ink is used for ink jet recording, the ink exhibits low permeability with respect to the recording medium (coated printing paper) and hence bleeding or agglomeration irregularities can be caused in the resultant images.

To deal with the problem described above, for example, Japanese Unexamined Patent Application Publication No. 2005-194500 (Patent Document 1) discloses a pigment-based ink that causes less bleeding and provides excellent gloss when used with special paper, the pigment-based ink containing a polysiloxane compound as a surfactant and an alkanediol such as 1,2-hexanediol as a solubilizing agent. Addition of glycerin or a diol such as 1,3-butanediol (For example, Japanese Unexamined Patent Application Publication Nos. 2003-213179 (Patent Document 2) and 2003-253167 (Patent Document 3)) and an alcohol solvent of a triol such as pentanetriol (For example, Japanese Unexamined Patent Application Publication No. 2006-249429 (Patent Document 4)) to ink has been proposed, the addition enabling control of the permeability of the ink into a recording medium, thereby providing images of high quality. Japanese Unexamined Patent Application Publication Nos. 2007-297595 (Patent Document 5) and 2007-297596 (Patent Document 6) propose ink sets that are excellent in terms of color reproducibility and gloss upon recording with a recording medium.

### RELATED ART

[Patent Document 1] Japanese Unexamined Patent Application Publication No. 2005-194500

[Patent Document 2] Japanese Unexamined Patent Application Publication No. 2003-213179

[Patent Document 3] Japanese Unexamined Patent Application Publication No. 2003-253167

[Patent Document 4] Japanese Unexamined Patent Application Publication No. 2006-249429

[Patent Document 5] Japanese Unexamined Patent Application Publication No. 2007-297595

[Patent Document 6] Japanese Unexamined Patent Application Publication No. 2007-297596

### SUMMARY OF THE INVENTION

The inventors of the present invention have found that, in an ink set at least including a yellow ink composition, a magenta ink composition, and a cyan ink composition, addition of specific alcohol solvents and a specific surfactant to each ink composition suppresses agglomeration of ink; and use of such an ink set can provide images free from white streaks and roughness even when the images are printed at a low resolution, and can provide good images, in particular, images having a good hue. The present invention is based on such findings.

Accordingly, an object of the present invention is to provide an ink set with which good images, in particular, images having a good hue can be provided.

An ink set according to the present invention at least includes a yellow ink composition, a magenta ink composition, and a cyan ink composition, wherein each ink composition at least contains a pigment, water, a water-soluble alcohol solvent, a slightly water-soluble alcohol solvent, and a surfactant; and the magenta ink composition contains, as the pigment, a solid solution between C.I. Pigment Red 202 and γ-type C.I. Pigment Violet 19.

Another ink set according to the present invention further contains a black ink composition.

Another ink set according to the present invention further contains a red ink composition.

The present invention can provide an ink set with which agglomeration of ink is suppressed, images free from white streaks and roughness can be provided even when printed at a low resolution, and good images, in particular, images having a good hue can be provided.

### BRIEF DESCRIPTION OF THE DRAWINGS

FIG. 1 shows comparison among color reproduction areas of the ink sets of Example 1 and Comparative Example 1 and patch patterns of color reproducibility of Japan Color.

FIG. 2 shows comparison among color reproduction areas of the ink sets of Example 2 and Comparative Example 1 and patch patterns of color reproducibility of Japan Color.

FIG. 3 shows comparison among color reproduction areas of the ink set of Example 3 and patch patterns of color reproducibility of Japan Color.

FIG. 4 shows comparison among color reproduction areas of the ink set of Example 4 and patch patterns of color reproducibility of Japan Color.

FIG. 5 shows comparison among color reproduction areas of the ink set of Comparative Example 1 and patch patterns of color reproducibility of Japan Color.

FIG. 6 shows comparison among color reproduction areas of the ink sets of Comparative Examples 2 and 1 and patch patterns of color reproducibility of Japan Color.

### DETAILED DESCRIPTION OF THE PRESENT INVENTION

An ink set according to the present invention at least contains a yellow ink composition, a magenta ink composition, and a cyan ink composition. Hereinafter, these ink compositions are described.

### DEFINITION

In the present specification, alkanediols, alkanetriols, and alkylene glycols may be linear or branched.

“Water-soluble” refers to a solubility in water (the amount of solute based on 100 g of water) of 10.0 g or more. “Slightly water-soluble” refers to a solubility in water (the amount of solute based on 100 g of water) of less than 1.0 g.

### <Yellow Ink Composition>

Examples of a pigment contained in a yellow ink composition used for an ink set according to the present invention include C.I. Pigment Yellow 1, 2, 3, 12, 14, 16, 17, 73, 74, 75, 83, 93, 95, 97, 98, 109, 110, 114, 128, 129, 138, 139, 147, 150, 151, 154, 155, 180, and 185. These pigments may be used alone or in combination. Among these pigments, one or more pigments selected from the group consisting of C.I. Pigment Yellow 74, 110, 128, 129, and 147 are particularly preferably used. In particular, combined use of C.I. Pigment Yellow 74 and 129 can provide images having a better hue.

The concentration of the solid content of a pigment in a yellow ink composition used for an ink set according to the present invention is not particularly restricted. However, in view of achieving appropriate color reproduction in recorded images, the concentration is preferably 6 wt % or more.

An alcohol solvent used for an ink composition for ink jet recording according to the present invention at least contains two types of organic solvents: a water-soluble alcohol solvent and a slightly water-soluble alcohol solvent. The presence of these two types of alcohol solvents as essential components suppresses agglomeration of ink on coated printing paper, in particular, on paper having a relatively high capability of absorbing ink such as art paper, paper for POD applications (for example, Ricoh business coat gloss 100 manufactured by Ricoh Company, Ltd., and the like), and special paper for laser printers (for example, LPCCTA4 manufactured by SEIKO EPSON CORPORATION, and the like) and images that are of high quality and free from white streaks and roughness can be provided even when the images are printed at a low resolution.

In the present specification, “agglomeration” refers to, when a solid image is printed (for example, when a square 6 inches per side is printed with a single color (this does not refer to the number of ink colors)), local density irregularities that are generated in the image and have similar colors. “Agglomeration” does not refer to the state in which there remain portions that are not covered with ink on the surfaces of recording media. “White streaks” refer to, when a solid image is printed (for example, when a square of 6 inches per side is printed with a single color), a phenomenon in which there are no local color density irregularities having similar colors and there remain streak-shaped portions that are not covered with ink on the surfaces of recording media in the driving direction of a recording head. “Roughness” or “filling failure” refers to, when a solid image is printed in the same manner as described above, a phenomenon in which there are no local color density irregularities having similar colors, there remain portions that are not covered with ink on the surfaces of recording media, and the surfaces of the recording media have granulated roughness.

The mechanism in which the addition of a water-soluble alcohol solvent as well as a slightly water-soluble alcohol solvent as essential components results in images that are of high quality and free from white streaks and roughness remains uncertain. However, the mechanism is presumably as follows.

Agglomeration of ink occurring in recording on coated printing paper is caused presumably because ink dots have high surface tension and the contact angle between a surface of coated printing paper and ink droplets is high and hence the coated printing paper rejects ink. Even when white streaks and filling failure occur in recording at a low resolution, a decrease in the surface tension of ink adhering to a surface of coated printing paper suppresses the agglomeration of the ink.

White streaks and filling failure occurring in recording at a low resolution are caused presumably because ink dots adhering to a surface of coated printing paper come into contact with neighboring ink dots and undried ink of these ink dots spread into each other, so that the undried ink flows among the ink dots. This ink flowing among ink dots is caused probably because neighboring ink dots have different drying times caused by a difference in time of adhering between the ink dots, the size of droplets at the time of adhering, and the like. Thus, to provide images of high quality in which agglomeration of ink is suppressed and white streaks and roughness are not generated even when the images are printed at a low resolution, ink having a low surface tension and a low flowability is preferably made adhere to coated printing paper.

However, unless a permeable wetting agent is used to reduce the flowability of ink, ink dots adhering to a surface of coated printing paper dry more rapidly and the ink is also absorbed more rapidly. Thus, the time in which adhering undried ink dots spread into each other is not provided and, as a result, white streaks and filling failure are presumably caused in recording at a low resolution.

The water-soluble alcohol solvent used in the present invention is not particularly restricted. However, preferred is use of one or more among water-soluble alkanediols and alkylene glycols, or combined use of one or more among water-soluble alkanediols and alkylene glycols and one or more water-soluble alkanetriols.

The water-soluble alkanediol described above is not particularly restricted. However, the water-soluble alkanediol preferably contains one or more alkanediols with main chains including 4 to 6 carbon atoms. More preferably, the water-soluble alkanediol contains a 1,2-alkanediol that may optionally include a branched chain and a 1,3-alkanediol that may optionally include a branched chain.

The above-described 1,2-alkanediol that may optionally include a branched chain is not particularly restricted, and preferred examples of the 1,2-alkanediol include 1,2-hexanediol, 1,2-pentanediol, 1,2-butanediol, 4-methyl-1,2-pentanediol, and 3,3-dimethyl-1,2-butanediol. Among these alkanediols, more preferred are water-soluble alkanediols that have a surface tension of 28 mN/m or less when turned into 15% aqueous solutions. Particularly preferred are 1,2-hexanediol (surface tension: 26.7 mN/m), 4-methyl 1,2-pentanediol (surface tension: 25.4 mN/m), and 3,3-dimethyl-1,2-butanediol (surface tension: 26.1 mN/m). In view of odor during printing, 1,2-hexanediol is more preferred.

The above-described 1,3-alkanediol that may optionally include a branched chain is not particularly restricted and preferred examples of the 1,3-alkanediol include 3-methyl-1,3-butanediol and 2-methyl-1,3-propanediol.

The above-described alkylene glycol is not particularly restricted and preferred examples of the alkylene glycol include diethylene glycol, dipropylene glycol, triethylene glycol, and tripropylene glycol. Of these examples, dipropylene glycol, which has six carbon atoms in its main chain, is more preferred in view of a clogging recovery property.

The above-described water-soluble alkanetriol is a viscous substance like glycerin. The above-described water-soluble alkanetriol is a permeable lubricant having a lower surface tension than that of glycerin. For example, as to the viscosity of 1,2,6-hexanetriol turned into a 10% aqueous solution, the solution has a surface tension of 54 mN/m. A 10% aqueous solution of 3-methylpentane-1,3,5-triol (manufactured by TOKYO CHEMICAL INDUSTRY CO., LTD., CAS: 7564-64-9) has a surface tension of 49 mN/m.

The above-described water-soluble alkanetriol is preferably an alkanetriol with a main chain including 5 to 10 carbon atoms. Examples of such an alkanetriol include 1,2,6-hexanetriol and 3-methylpentane-1,3,5-triol. Of these examples, 1,2,6-hexanetriol is preferred in view of an intermittent printing property of ink, and 3-methylpentane-1,3,5-triol is preferred in view of a fixing property of ink.

The slightly water-soluble alcohol solvent used in the present invention is preferably an alkanediol, more preferably an alkanediol containing 7 or more carbon atoms, and still more preferably an alkanediol containing 7 to 10 carbon atoms. Examples of such an alkanediol include 1,2-heptanediol, 1,2-octanediol, 5-methyl-1,2-hexanediol, 4-methyl-1,2-hexanediol, and 4,4-dimethyl-1,2-pentanediol. Of these alkanediols, 1,2-octanediol is more preferable.

As for the two types of alcohol solvents described above, the content ratio of the slightly water-soluble alcohol solvent to the water-soluble alcohol solvent is preferably 1:1 to 1:6, more preferably 1:1 to 1:3. By achieving this range, the slightly water-soluble alcohol solvent can be dissolved in ink with stability, thereby enhancing the ejection stability of the ink. When the proportion of the water-soluble alcohol solvent is made within the range above, both reduction of the initial viscosity of ink and reduction of agglomeration irregularities can be easily achieved. When the proportion of the water-soluble alcohol solvent is made within the range above, the slightly water-soluble alcohol solvent is easily dissolved in ink with stability, thereby suppressing changes in the viscosity of the ink over time and maintaining the storage stability of the ink with ease.

The content ratio of the slightly water-soluble alcohol solvent to the water-soluble alkanediol is preferably 1:1 to 1:6, more preferably 1:1 to 1:3. By achieving this range, the slightly water-soluble alcohol solvent can be dissolved in ink with stability, thereby enhancing the ejection stability of the ink. When the proportion of the water-soluble alkanediol is made within the range above, both reduction of the initial viscosity of ink and reduction of agglomeration irregularities can be easily achieved. When the proportion of the water-soluble alkanediol is made within the range above, the slightly water-soluble alcohol solvent is easily dissolved in ink with stability, thereby suppressing changes in the viscosity of the ink over time and maintaining the storage stability of the ink with ease. As described above, the water-soluble alkanediol preferably contains one or more alkanediols with main chains including 4 to 6 carbon atoms.

The content ratio of the slightly water-soluble alcohol solvent to the alkylene glycol is preferably 1:1 to 1:6, more preferably 1:1 to 1:3. By achieving this range, the slightly water-soluble alcohol solvent can be dissolved in ink with stability, thereby enhancing the ejection stability of the ink. When the proportion of the alkylene glycol is made within the range above, both reduction of the initial viscosity of ink and reduction of agglomeration irregularities can be easily achieved. When the proportion of the alkylene glycol is made within the range above, the slightly water-soluble alcohol solvent is easily dissolved in ink with stability, thereby suppressing changes in the viscosity of the ink over time and maintaining the storage stability of the ink with ease.

The content ratio of the slightly water-soluble alcohol solvent to the water-soluble alkanetriol is preferably 1:1 to 1:8, more preferably 1:1 to 1:6. By achieving this range, the initial viscosity of ink can be reduced and a good clogging recovery property can be achieved. When the proportion of the water-soluble alkanetriol is made within the range above, the initial viscosity of ink can be reduced and degradation of the drying property of the ink can be suppressed. When the proportion of the water-soluble alkanetriol is made within the range above, a good clogging recovery property can be achieved and degradation of the drying property can be suppressed. As a result, sufficiently long time in which undried ink spreads can be provided and hence the ink can cover recording media, thereby decreasing the occurrence of white streaks.

The content ratio of the water-soluble alkanediol to the water-soluble alkanetriol is preferably 2:1 to 1:18, more preferably 1:1 to 1:3. By achieving this range, white streaks and roughness can be further suppressed in printing at a low resolution on coated printing paper. When the proportion of the water-soluble alkanetriol is made within the range above, the initial viscosity of ink can be reduced and degradation of the drying property of the ink can be suppressed. When the proportion of the water-soluble alkanetriol is made within the range above, a good clogging recovery property can be achieved and degradation of the drying property can be suppressed. As a result, sufficiently long time in which undried ink spreads can be provided and hence the ink can cover recording media, thereby decreasing the occurrence of white streaks. As described above, the water-soluble alkanediol preferably contains one or more alkanediols with main chains including 4 to 6 carbon atoms.

The content ratio of the alkylene glycol to the water-soluble alkanetriol is preferably 2:1 to 1:18, more preferably 1:1 to 1:3. By achieving this range, white streaks and roughness can be further suppressed in printing at a low resolution on coated printing paper. When the proportion of the water-soluble alkanetriol is made within the range above, the initial viscosity of ink can be reduced and degradation of the drying property of the ink can be suppressed. When the proportion of the water-soluble alkanetriol is made within the range above, a good clogging recovery property can be achieved and degradation of the drying property can be suppressed. As a result, sufficiently long time in which undried ink spreads can be provided and hence the ink can cover recording media, thereby decreasing the occurrence of white streaks.

The content ratio of the water-soluble alkanediol to the alkylene glycol is preferably 1:1 to 1:18, more preferably 1:1 to 1:6. By achieving this range, the initial viscosity of ink is reduced and change in the viscosity of the ink over time is suppressed, thereby maintaining the storage stability of the ink with ease.

According to the present invention, the total content of the slightly water-soluble alcohol solvent and the water-soluble alcohol solvent is preferably 11 wt % or less based on the ink composition. By making the total content within this range, agglomeration irregularities are not generated in recording media having low capability of absorbing ink such as coated printing paper and excellent ejection stability is also provided.

According to the present invention, the total content of the slightly water-soluble alcohol solvent and the water-soluble alkanediol is preferably 11 wt % or less based on the ink composition. By making the total content within this range, agglomeration irregularities are not generated in recording media having low capability of absorbing ink such as coated printing paper and excellent ejection stability is also provided. As described above, the water-soluble alkanediol preferably contains one or more alkanediols with main chains including 4 to 6 carbon atoms.

According to the present invention, the total content of the slightly water-soluble alcohol solvent and the alkylene glycol is preferably 11 wt % or less based on the ink composition. By making the total content within this range, agglomeration irregularities are not generated in recording media having low capability of absorbing ink such as coated printing paper and excellent ejection stability is also provided.

According to the present invention, the total content of the slightly water-soluble alcohol solvent and the water-soluble alkanetriol is preferably 11 wt % or less based on the ink composition. By making the total content within this range, agglomeration irregularities are not generated in recording media having low capability of absorbing ink such as coated printing paper. Additionally, good ejection stability is provided and curling is sufficiently suppressed.

The content of the water-soluble alcohol solvent is preferably 1 to 11 wt %, more preferably 4 to 8 wt %, based on the total ink composition. When the content of the water-soluble alcohol solvent is within the range of 4 to 8 wt %, the slightly water-soluble alcohol solvent can be dissolved in ink and the initial viscosity of the ink can be reduced to a small value.

The content of the slightly water-soluble alcohol solvent is preferably 1 to 3 wt %, more preferably 1.5 to 2.5 wt %, based on the total ink composition. When the content of the slightly water-soluble alcohol solvent is 1.5 to 2.5 wt %, there scarcely occurs the case where printing irregularities are generated on recording media having low capability of absorbing ink such as coated printing paper or the case where the slightly water-soluble alcohol solvent is not completely dissolved in ink.

The content of the water-soluble alkanediol is preferably 1 to 11 wt %, more preferably 3 to 8 wt %, based on the total ink composition. When the content of the water-soluble alkanediol is within the range of 3 to 8 wt %, the slightly water-soluble alcohol solvent can be dissolved in ink and the initial viscosity of the ink can be reduced to a small value. As described above, the water-soluble alkanediol preferably contains one or more alkanediols with main chains including 4 to 6 carbon atoms.

The content of the alkylene glycol is preferably 1 to 11 wt %, more preferably 3 to 8 wt %, based on the total ink composition. When the content of the alkylene glycol is within the range of 3 to 8 wt %, the slightly water-soluble alcohol solvent can be dissolved in ink and the initial viscosity of the ink can be reduced to a small value.

The content of the water-soluble alkanetriol is preferably 1 to 11 wt %, more preferably 3 to 8 wt %, based on the total ink composition. When the content of the water-soluble alkanetriol is within the range of 3 to 8 wt %, there scarcely occurs the case where white streaks or roughness occur in printing at a low resolution on coated printing paper or the case where the drying property of printed products immediately after printing is poor.

Ink compositions according to the present invention contain a surfactant as an essential component. By using a surfactant for recording media on the surfaces of which a resin for receiving ink is coated, images having excellent gloss can be provided even with recording media such as photographic paper, in which gloss is more valued. In particular, even when recording media, such as coated printing paper, having a coated layer for receiving oil-based ink in the reception layer on the surfaces of the media are used, use of a surfactant can prevent bleeding among colors and blushing caused by reflected light, the blushing occurring with an increase in the adhesion amount of ink.

As for a surfactant used in the present invention, an organopolysiloxane-based surfactant is preferably used. Use of an organopolysiloxane-based surfactant enhances the wettability of the surfaces of recording media upon formation of recording images, thereby enhancing permeability of ink into the surfaces of recording media. When an organopolysiloxane-based surfactant is used, the presence of the two types of alcohol solvents as described above enhances the solubility of the surfactant in ink, thereby reducing the occurrence of generation of insoluble matter and the like. Thus, an ink composition exhibiting more excellent ejection stability can be provided.

For the surfactant described above, commercially available surfactants may be used. Examples of such surfactants include OLFINE PD-501 (manufactured by Nissin Chemical Industry Co., Ltd.), OLFINE PD-502 (manufactured by Nissin Chemical Industry Co., Ltd.), and OLFINE PD-570 (manufactured by Nissin Chemical Industry Co., Ltd.).

The organopolysiloxane-based surfactant more preferably includes one or more compounds represented by the following Formula (I):

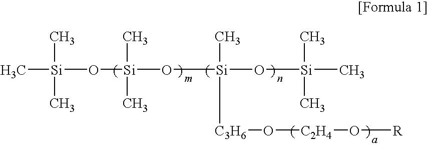

(In the formula, R represents a hydrogen atom or a methyl group, a represents an integer of 2 to 11, m represents an integer of 2 to 50, and n represents an integer of 1 to 5), or one or more compounds represented by Formula (I) above wherein R represents a hydrogen atom or a methyl group, a represents an integer of 2 to 13, m represents an integer of 2 to 50, and n represents an integer of 1 to 5. More preferably, the organopolysiloxane-based surfactant includes one or more compounds represented by Formula (I) above wherein R represents a hydrogen atom or a methyl group, a represents an integer of 2 to 13, m represents an integer of 2 to 50, and n represents an integer of 1 to 8. More preferably, the organopolysiloxane-based surfactant includes one or more compounds represented by Formula (I) above wherein R represents a methyl group, a represents an integer of 6 to 18, m represents 0, and n represents 1. Use of such specific organopolysiloxane-based surfactants further improves ink in terms of agglomeration irregularities even when coated printing paper is used as a recording media in printing.

As for compounds according to Formula (I) above, more preferred are use of compounds in which a represents an integer of 2 to 5, m represents an integer of 20 to 40, and n represents an integer of 2 to 4; compounds in which a represents an integer of 7 to 11, m represents an integer of 30 to 50, and n represents an integer of 3 to 5; compounds in which a represents an integer of 9 to 13, m represents an integer of 2 to 4, and n represents an integer of 1 to 2; or compounds in which a represents an integer of 6 to 10, m represents an integer of 10 to 20, and n represents an integer of 4 to 8. Use of such compounds can further improve ink in terms of agglomeration irregularities.

More preferred is to use a compound according to Formula (I) above wherein R represents a hydrogen atom, a represents an integer of 2 to 5, m represents an integer of 20 to 40, and n represents an integer of 2 to 4; or a compound according to Formula (I) above wherein a represents an integer of 7 to 11, m represents an integer of 30 to 50, and n represents an integer of 3 to 5. Use of such a compound can further improve ink in terms of agglomeration irregularities and bleeding.

More preferred is to use a compound according to Formula (I) above wherein R represents a methyl group, a represents an integer of 9 to 13, m represents an integer of 2 to 4, and n represents an integer of 1 to 2; or a compound according to Formula (I) above wherein a represents an integer of 6 to 10, m represents an integer of 10 to 20, and n represents an integer of 4 to 8. Use of such a compound can further improve ink in terms of agglomeration irregularities and bleeding.

More preferred is to use a compound according to Formula (I) above wherein R represents a methyl group, a represents an integer of 6 to 12, m represents 0, and n represents 1. Use of such a compound can further improve ink in terms of agglomeration irregularities and bleeding.

Most preferred is to use a mixture of a compound according to Formula (I) above wherein R represents a hydrogen atom, a represents an integer of 7 to 11, m represents an integer of 30 to 50, and n represents an integer of 3 to 5; a compound according to Formula (I) above wherein R represents a methyl group, a represents an integer of 9 to 13, m represents an integer of 2 to 4, and n represents an integer of 1 to 2; and a compound according to Formula (I) above wherein R represents a methyl group, a represents an integer of 6 to 10, m represents an integer of 10 to 20, and n represents an integer of 4 to 8. Use of such compounds can still further improve ink in terms of agglomeration irregularities and bleeding.

Most preferred is to use a mixture of a compound according to Formula (I) above wherein R represents a hydrogen atom, a represents an integer of 7 to 11, m represents an integer of 30 to 50, and n represents an integer of 3 to 5; a compound according to Formula (I) above wherein R represents a methyl group, a represents an integer of 9 to 13, m represents an integer of 2 to 4, and n represents an integer of 1 to 2; and a compound according to Formula (I) above wherein R represents a methyl group, a represents an integer of 6 to 18, m represents 0, and n represents 1. Use of such compounds still further improve ink in terms of agglomeration irregularities and bleeding.

An ink composition according to the present invention preferably contains the surfactant described above in an amount of 0.01 to 1.0 wt %, more preferably 0.05 to 0.50 wt %. Combined use of the surfactant described above with R being a methyl group and the surfactant described above with R being a hydrogen atom is more preferable because letters in a small font are not blurred. In particular, the content of a surfactant is preferably larger in the case of using the surfactant described above with R being a methyl group than in the case of using the surfactant described above with R being H in view of agglomeration irregularities of ink.

The more content of the surfactant described above with R being H is more preferable relative to the content of the surfactant described above with R being a methyl group. As a result, ink can be improved in terms of agglomeration irregularities and bleeding even in coated printing paper that tends to reject ink and has a slow ink permeation speed such as cast coated paper.

An ink composition according to the present invention may further contain another surfactant, specifically, an acetylene-glycol-based surfactant, an anionic surfactant, a nonionic surfactant, an ampholytic surfactant, or the like.

Among these surfactants, examples of the acetylene-glycol-based surfactant include 2,4,7,9-tetramethyl-5-decyne-4,7-diol, 3,6-dimethyl-4-octyne-3,6-diol, 3,5-dimethyl-1-hexyne-3ol, and 2,4-dimethyl-5-hexyne-3-ol. For the acetylene-glycol-based surfactant, commercially available surfactants may be used. Examples of such surfactants include OLFINE E1010, STG, Y (trade names, manufactured by Nissin Chemical Industry Co., Ltd.), and Surfynol 61, 104, 82, 465, 485, and TG (trade names, manufactured by Air Products and Chemicals Inc.).

The yellow ink composition preferably contains, as a dispersing agent for dispersing a pigment, at least one resin selected from styrene-acrylic-acid-based copolymer resins, urethane-based resins, fluorene-based resins, and oxyethyl acrylate-based resins. These copolymer resins adsorb to pigments, thereby enhancing the dispersion properties of the pigments.

Specific examples of a hydrophobic monomer for the copolymer resins include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethylhexyl acrylate, 2-ethylhexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylolpropane triacrylate, trimethylolpropane trimethacrylate, glycerol acrylate, glycerol methacrylate, styrene, methyl styrene, and vinyltoluene. These monomers may be used alone or in combination.

Specific examples of a hydrophilic monomer include acrylic acid, methacrylic acid, maleic acid, and itaconic acid.

In view of achieving appropriate gloss and prevention of bronzing in color images and achieving appropriate storage stability of an ink composition, and permitting formation of color images having more excellent gloss, a copolymer resin of the hydrophobic monomer and the hydrophilic monomer is preferably at least any one of styrene-(meth)acrylic acid copolymer resins, styrene-methyl styrene-(meth)acrylic acid copolymer resins, styrene-maleic acid copolymer resins, (meth)acrylic acid-(meth)acrylate copolymer resins, and styrene-(meth)acrylic acid-(meth)acrylate copolymer resins.

The above-described copolymer resin may also be a resin (styrene-acrylic acid resin) containing a polymer obtained by effecting reaction between styrene and acrylic acid or acrylate. Alternatively, the copolymer resin may also be an acrylic-acid-based water-soluble resin. Alternatively, the copolymer resin may also be a salt of these resins such as a sodium salt, a potassium salt, or an ammonium salt.

In view of achieving appropriate gloss and prevention of bronzing in color images and achieving appropriate storage stability of an ink composition, and permitting formation of color images having more excellent gloss, the content of such a copolymer resin is preferably 10 to 50 parts by weight, more preferably 10 to 35 parts by weight, based on 100 parts by weight of the pigment described above.

In the present invention, use of a urethane resin as a pigment dispersing agent results in appropriate gloss and prevention of bronzing in color images, also results in appropriate storage stability of an ink composition, and permits formation of color images having more excellent gloss. A urethane resin is a resin containing a polymer obtained by effecting reaction between a diisocyanate compound and a diol compound. A urethane resin used in the present invention is preferably a resin containing a urethane bond and/or an amide bond and an acidic group.

Examples of the diisocyanate compound include aromatic aliphatic diisocyanate compounds such as hexamethylene diisocyanate and 2,2,4-trimethylhexamethylene diisocyanate, aromatic diisocyanate compounds such as toluoylene diisocyanate and phenylmethane diisocyanate, and modified compounds of the foregoing.

Examples of the diol compound include polyether-based compounds such as polyethylene glycol and polypropylene glycol, polyester-based compounds such as polyethylene adipate and polybutylene adipate, and polycarbonate-based compounds.

The above-described urethane resin preferably contains a carboxyl group.

In the present invention, a fluorene-based resin may also be used as a pigment dispersing agent.

The weight ratio between the copolymer resin and the urethane resin (the former/the latter) is preferably 1/2 to 2/1. In view of achieving appropriate gloss and prevention of bronzing in color images and also achieving appropriate storage stability of an ink composition, and permitting formation of color images having more excellent gloss, the weight ratio is more preferably 1/1.5 to 1.5/1.

The weight ratio between the solid content of the pigment and solid content other than the pigment (the former/the latter) is preferably 100/20 to 100/80 in view of achieving appropriate gloss and prevention of bronzing in color images and also achieving appropriate storage stability of an ink composition, and permitting formation of color images having more excellent gloss.

The content of the copolymer resin is preferably 10 to 50 parts by weight, more preferably 10 to 35 parts by weight, based on 100 parts by weight of the pigment described above in view of achieving appropriate gloss and prevention of bronzing in color images and also achieving appropriate storage stability of an ink composition, and permitting formation of color images having more excellent gloss.

The content of the urethane resin is preferably 10 to parts by weight, more preferably 10 to 35 parts by weight, based on 100 parts by weight of the pigment described above in view of achieving appropriate gloss and prevention of bronzing in color images and also achieving appropriate storage stability of an ink composition, and permitting formation of color images having more excellent gloss.

The content of the fluorene-based resin is preferably to 200 parts by weight, more preferably 10 to 80 parts by weight, based on 100 parts by weight of the pigment described above in view of achieving appropriate gloss and prevention of bronzing in color images and also achieving appropriate storage stability of an ink composition, and permitting formation of color images having more excellent gloss.

The total amount of the copolymer resin and the urethane resin to be used is preferably 90 parts by weight or less (more preferably 70 parts by weight or less) based on 100 parts by weight of the pigment described above in terms of achieving appropriate gloss and prevention of bronzing in color images and also achieving appropriate storage stability of an ink composition, and permitting formation of color images having more excellent gloss.

The acid value of the copolymer resin is preferably 50 to 320, more preferably 100 to 250, in view of achieving appropriate gloss and prevention of bronzing in color images and also achieving appropriate storage stability of an ink composition, and permitting formation of color images having more excellent gloss.

The acid value of the urethane resin is preferably 10 to 300, more preferably 20 to 100, in view of achieving appropriate gloss and prevention of bronzing in color images and also achieving appropriate storage stability of an ink composition, and permitting formation of color images having more excellent gloss. The acid value is an amount (mg) of KOH required for neutralizing 1 g of a resin.

The weight-average molecular weight (Mw) of the copolymer resin is preferably 2,000 to 30,000, more preferably 2,000 to 20,000, in view of achieving appropriate gloss and prevention of bronzing in color images and also achieving appropriate storage stability of an ink composition, and permitting formation of color images having more excellent gloss.

The weight-average molecular weight (Mw) of the urethane resin before being crosslinked is preferably 100 to 200,000, more preferably 1,000 to 50,000, in view of achieving appropriate gloss and prevention of bronzing in color images and also achieving appropriate storage stability of an ink composition, and permitting formation of color images having more excellent gloss. Mw is determined by, for example, GPC (gel permeation chromatography).

The glass transition temperature (Tg; determined in accordance with JISK6900) of the copolymer resin is preferably 30° C. or more, more preferably 50° C. to 130° C., in view of achieving appropriate gloss and prevention of bronzing in color images and also achieving appropriate storage stability of an ink composition, and permitting formation of color images having more excellent gloss.

The glass transition temperature (Tg; determined in accordance with JISK6900) of the urethane resin is preferably −50° C. to 200° C., more preferably −50° C. to 100° C., in view of achieving appropriate gloss and prevention of bronzing in color images and also achieving appropriate storage stability of an ink composition, and permitting formation of color images having more excellent gloss.

The copolymer resin in a fluid dispersion of a pigment adsorbs to the pigment or is free from the pigment. The largest particle size of the copolymer resin is preferably 0.3 μm or less and the average particle size of the copolymer resin is more preferably 0.2 μm or less (still more preferably 0.1 μm or less) in view of achieving appropriate gloss and prevention of bronzing in color images and also achieving appropriate storage stability of an ink composition, and permitting formation of color images having more excellent gloss. The average particle size is an average value of dispersion sizes (50% cumulative size) of particles actually formed of a pigment in a fluid dispersion. The average particle size can be determined with, for example, a Microtrac UPA (Microtrac Inc.).

The fluorene resin described above is not restricted as long as the resin has a fluorene structure. Such a fluorene resin can be obtained by, for example, copolymerizing the following monomer units.

cyclohexane, 5-isocyanate-1-(isocyanatemethyl)-1,3,3-trimethyl (CAS No. 4098-71-9)

ethanol, 2,2′-[9H-fluorene-9-ylidenebis(4,1-phenyleneoxy)]bis (CAS No. 117344-32-8)

propionic acid, 3-hydroxy-2-(hydroxymethyl)-2-methyl (CAS No. 4767-03-7)

ethanamine, N,N-diethyl- (CAS No. 121-44-8)

In the present invention, an oxyethyl acrylate-based resin may also be used as a pigment dispersing agent. Containing an oxyethyl acrylate-based resin as a dispersing agent for dispersing a pigment can provide an excellent clogging recovery property and excellent storage stability in high temperature. Combined use of an oxyethyl acrylate-based resin and a solid solution between C.I. Pigment Red 202 and γ-type C.I. Pigment Violet 19 can provide a more excellent clogging recovery property and more excellent storage stability in high temperature.

The above-described oxyethyl acrylate-based resin is not particularly restricted and is preferably a compound represented by Formula (II) below. A compound represented by Formula (II) below is, for example, a resin containing the following monomers in molar proportions: 45% to 55% ortho-hydroxyethylated phenylphenol acrylate (CAS No. 72009-86-0), 20% to 30% acrylic acid (CAS No. 79-10-7), and 20% to 30% methacrylic acid (CAS No. 79-41-4). These may be used alone or in combination. The proportions of the above-described monomers are not particularly restricted and preferred proportions are 70% to 85% ortho-hydroxyethylated phenylphenol acrylate (CAS No. 72009-86-0), 5% to 15% acrylic acid (CAS No. 79-10-7), and 10% to 20% methacrylic acid (CAS No. 79-41-4).

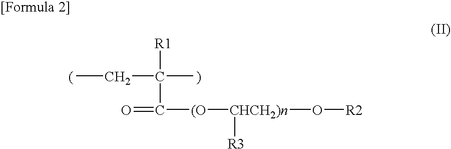

(where R1 and/or R3 represents a hydrogen atom or a methyl group, R2 represents an alkyl group or an aryl group, and n represents an integer of 1 or more).

Preferred examples of a compound represented by Formula (II) above include nonylphenoxy polyethylene glycol acrylate and polypropylene glycol #700 acrylate.

The content of the oxyethyl acrylate-based resin is preferably 10 to 40 parts by weight, more preferably 15 to 25 parts by weight, based on 100 parts by weight of the pigment described above in view of achieving an appropriate initial viscosity of an ink composition and appropriate storage stability of the ink composition, suppressing agglomeration irregularities, and permitting formation of color images having an excellent filling property.

The total proportions of resins derived from monomers having hydroxyl groups selected from the group of acrylic acid and methacrylic acid in the oxyethyl acrylate-based resin is preferably 30% to 70%, more preferably 40% to 60%, in view of achieving an appropriate initial viscosity of an ink composition and appropriate storage stability of the ink composition, and a clogging recovery property.

The weight-average molecular weight (Mw) of the oxyethyl acrylate-based resin before being crosslinked is preferably 30,000 to 100,000, more preferably 50,000 to 80,000, in view of achieving an appropriate initial viscosity of an ink composition and appropriate storage stability of the ink composition. Mw is determined by, for example, GPC (gel permeation chromatography).

The oxyethyl acrylate-based resin in a fluid dispersion of a pigment adsorbs to the pigment or is free from the pigment. The largest particle size of the copolymer resin is preferably 0.3 μm or less and the average particle size of the copolymer resin is more preferably 0.2 μm or less (still more preferably 0.1 μm or less) in view of achieving appropriate gloss and prevention of bronzing in color images and also achieving appropriate storage stability of an ink composition, and permitting formation of color images having more excellent gloss. The average particle size is an average value of dispersion sizes (50% cumulative size) of particles actually formed of a pigment in a fluid dispersion. The average particle size can be determined with, for example, a Microtrac UPA (Microtrac Inc.).

Alternatively, a surfactant may also be used as a dispersing agent. Examples of such a surfactant include anionic surfactants such as fatty acid salts, higher alkyl dicarboxylates, higher alcohol sulfates, higher alkyl sulfonates, condensation products between higher fatty acids and amino acids, sulfosuccinates, naphthenates, liquid fatty oil sulfates, and alkylaryl sulfonates; cationic surfactants such as fatty acid amine salts, quaternary ammonium salts, sulfonium salts, and phosphonium; and nonionic surfactants such as polyoxyethylene alkyl ethers, polyoxyethylene alkyl esters, sorbitan alkyl esters, and polyoxyethylene sorbitan alkyl esters. When the surfactants described above are added to ink compositions, as a matter of course, these surfactants also function as surfactants.

A yellow ink composition used in the present invention further contains water as a solvent as well as the alkanediol, the surfactant, and other various additives that are described above. For water, preferably used is pure water or ultrapure water such as ion-exchanged water, ultrafiltration water, reverse osmosis water, or distilled water. In particular, preferred are these waters that have been subjected to a sterilization treatment such as ultraviolet radiation or addition of hydrogen peroxide because generation of fungi and bacteria is prevented for a long period of time.

It is preferred that a yellow ink composition according to the present invention contain a permeating agent in addition to the components described above.

For a permeating agent, glycol ethers can be suitably used.

Specific examples of the glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol-iso-propyl ether, dipropylene glycol mono-n-butyl ether, dipropylene glycol mono-tert-butyl ether, and 1-methyl-1-methoxybutanol. These glycol ethers can be used alone or in combination.

Among the glycol ethers described above, preferred are alkyl ethers of polyhydric alcohols. In particular, preferred are ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether. More preferred is triethylene glycol mono-n-butyl ether.

The amount of the permeating agent to be added may be appropriately determined. This amount is preferably about 0.1 to 30 wt % and more preferably about 1 to 20 wt %.

It is preferred that the yellow ink composition contain a recording-media solubilizer in addition to the components described above.

For a recording-media solubilizer, pyrrolidones such as N-methyl-2-pyrrolidone can be suitably used. The amount of the recording-media solubilizer to be added may be appropriately determined. This amount is preferably about 0.1 to 30 wt % and more preferably about 1 to 20 wt %.

It is preferred that a wetting agent is substantially absent from a yellow ink composition used in the present invention. Since a wetting agent functions to prevent ink from drying and solidifying in ink jet nozzles and the like, such ink does not dry after being ejected onto synthetic paper with particularly low capability of absorbing ink, which can cause a problem in high-speed printing. When ink containing a wetting agent is used, subsequent ink is put on a recording medium on which unabsorbed ink is still present. This can cause generation of agglomeration irregularities.

For these reasons, substantial absent of a wetting agent is preferred in the present invention when recording media having particularly low capability of absorbing ink are used. When ink has dried and solidified in ink jet nozzles, the dried ink can be dissolved again with a solution containing a wetting agent.

In particular, substantial absent of a wetting agent having a vapor pressure of 2 mPa or less at 25° C. is preferred in the present invention. “Substantial absent” refers to that the amount of such a wetting agent to be added is less than 1 wt % based on the ink composition.

When the content of a wetting agent having a vapor pressure of 2 mPa or less at 25° C. is less than 1 wt % based on ink, printing can be conducted by an ink jet recording method not only for recording media having low capability of absorbing ink such as coated printing paper but also for metal and plastic that has no capability of absorbing ink. It is obvious to those skilled in the art that some permeating solvents described above also function as wetting agents. However, it is understood in the present specification that the permeating solvents described above are not categorized as wetting agents. Also, it is understood in the present specification that the alkanediols described above are not categorized as wetting agents.

Wetting agents in the present specification refer to wetting agents used for ordinary ink compositions. Ink compositions used in the present invention may contain alcohol other than the alcohol solvents described above. Specific examples of such alcohol include trimethylolpropane, trimethylolmethane, and trimethylolethane. Such wetting agents can be appropriately added when recording media having low capability of absorbing ink such as coated printing paper are used.

A yellow ink composition used in the present invention may further contain an agent for preventing clogging of nozzles, a preservative, an anti-oxidizing agent, a conductivity adjusting agent, a pH adjusting agent, a viscosity modifier, a surface tension adjusting agent, an oxygen absorbent, or the like.

Examples of the preservative and a fungicide include sodium benzoate, sodium pentachlorophenol, sodium 2-pyridinethiol-1-oxide, sodium sorbate, sodium dehydroacetate, and 1,2-dibenzynethiazoline-3-one (Proxel CRL, Proxel BND, Proxel GXL, Proxel XL-2, and Proxel TN manufactured by ICI Corporation).

Examples of the pH adjusting agent, a solubilizing agent, and the anti-oxidizing agent include amines such as diethanolamine, triethanolamine, propanolamine, and morpholine, and modified amines of the foregoing; inorganic salts such as potassium hydroxide, sodium hydroxide, and lithium hydroxide; ammonium hydroxide, quaternary ammonium hydroxide (tetramethylammonium and the like); carbonates such as potassium carbonate, sodium carbonate, and lithium carbonate; phosphates; N-methyl-2-pyrrolidone; ureas such as urea, thiourea, and tetramethylurea; allophanates such as allophanate, and methylallophanate; biurets such as biuret, dimethylbiuret, and tetramethylbiuret; and L-ascorbic acid, and salts of L-ascorbic acid.

A yellow ink composition used in the present invention may further contain an anti-oxidizing agent and an ultraviolet absorbing agent. Examples of such agents include Tinuvin 328, 900, 1130, 384, 292, 123, 144, 622, 770, and 292, Irgacor 252 153, Irganox 1010, 1076, and 1035, MD 1024, (manufactured by Ciba Specialty Chemicals), and oxides of lanthanide.

The ink composition can be prepared by dispersing and mixing the components described above by an appropriate method. Preferably, a pigment, a polymer dispersing agent, and water are mixed with a proper dispersing apparatus such as a ball mill, a sand mill, an attritor, a roll mill, an agitator mill, a Henschel mixer, a colloid mill, an ultrasonic homogenizer, a jet mill, or an Angmill to prepare a fluid dispersion in which the pigment is uniformly dispersed. After that, a separately prepared resin (resin emulsion), water, a water-soluble organic solvent, sugar, a pH adjusting agent, a preservative, a fungicide, and the like are added to the fluid dispersion and fully dissolved to prepare an ink solution. This solution is fully stirred and subsequently filtrated for removing coarse particle size and impurities that cause clogging. Thus, a target ink composition can be obtained.

### <Magenta Ink Composition>

Examples of a pigment contained in a magenta ink composition used for an ink set according to the present invention include C.I. Pigment Red 5, 7, 12, 48 (Ca), 48 (Mn), 57 (Ca), 57:1, 112, 122, 123, 168, 184, 202, and 209; and C.I. Pigment Violet 19. These pigments may be used alone or in combination. Among these pigments, one or more pigments selected from the group consisting of C.I. Pigment Red 122, 202, and 209 and C.I. Pigment Violet 19 are particularly preferably used. In particular, use of a solid solution between γ-type C.I. Pigment Violet 19 and C.I. Pigment Red 202 as a pigment can provide images having a better hue.

Herein, “a solid solution between γ-type C.I. Pigment Violet 19 and C.I. Pigment Red 202” refers to crystals in which γ-type C.I. Pigment Violet 19 and C.I. Pigment Red 202 dissolve into each other in the state of solid.

The amount ratio between γ-type C.I. Pigment Violet 19 and C.I. Pigment Red 202 in the solid solution can be appropriately adjusted in the scope of the present invention. The weight of γ-type C.I. Pigment Violet 19 is preferably larger than the weight of C.I. Pigment Red 202 in the solid solution.

The concentration of the solid content of a pigment in a magenta ink composition used for an ink set according to the present invention is not particularly restricted. However, in view of achieving appropriate color reproduction in recorded images, the concentration is preferably 6 wt % or more.

Alcohol solvents, a surfactant, a dispersing agent, water, other components, and the like as in the yellow ink composition can also be added to the magenta ink composition.

### <Cyan Ink Composition>

A pigment contained in a cyan ink composition used for an ink set according to the present invention is not particularly restricted. Examples of such a pigment include C.I. Pigment Blue 1, 2, 3, 15:3, 15:4, 15:34, 16, 22, and 60; and C.I. Bat Blue 4 and 60. These pigments may be used alone or in combination. Among these pigments, use of C.I. Pigment Blue 15:3 and/or 15:4 is particularly preferred. In particular, use of C.I. Pigment Blue 15:3 can provide images having a better hue.

The concentration of the solid content of a pigment in a cyan ink composition used for an ink set according to the present invention is not particularly restricted. However, in view of achieving appropriate color reproduction in recorded images, the concentration is preferably 6 wt % or more.

Alcohol solvents, a surfactant, a dispersing agent, water, other components, and the like as in the yellow ink composition can also be added to the cyan ink composition.

### <Black Ink Composition>

An ink set according to the present invention preferably further contains a black ink composition. A pigment contained in a black ink composition for an ink set according to the present invention is not particularly restricted. Examples of such a pigment include inorganic pigments such as carbons like lamp black (C.I. Pigment Black 6), acetylene black, furnace black (C.I. Pigment Black 7), channel black (C.I. Pigment Black 7), and carbon black (C.I. Pigment Black 7) and iron oxide pigments; and organic pigments such as aniline black (C.I. Pigment Black 1). In the present invention, carbon black is preferably used. Specific examples of carbon black include #2650, #2600, #2300, #2200, #1000, #980, #970, #966, #960, #950, #900, #850, MCF-88, #55, #52, #47, #45, #45L, #44, #33, #32, #30 (these listed so far are manufactured by Mitsubishi Chemical Corporation), SpecialBlaek4A, 550, Printex95, 90, 85, 80, 75, 45, 40 (these listed so far are manufactured by Degussa Corporation), Regal660, Rmogu1L, monarch1400, 1300, 1100, 800, 900 (these listed so far are manufactured by Cabot Corporation), Raven 7000, 5750, 5250, 3500, 3500, 2500ULTRA, 2000, 1500, 1255, 1200, 1190ULTRA, 1170, 1100ULTRA, and Raven5000UIII (these listed so far are manufactured by Columbian Corporation). Among these pigments, in particular, use of C.I. Pigment Black 6 and/or C.I. Pigment Black 7 can provide images having a better hue.

The concentration of the solid content of a pigment in a black ink composition used for an ink set according to the present invention is not particularly restricted. However, in view of achieving appropriate color reproduction in recorded images, the concentration is preferably 6 wt % or more.

Alcohol solvents, a surfactant, a dispersing agent, water, other components, and the like as in the yellow ink composition can also be added to the black ink composition.

### <Red Ink Composition>

An ink set according to the present invention preferably further contains a red ink composition. For a red ink composition for an ink set according to the present invention, one or more selected from the group consisting of C.I. Pigment Red (PR) 17, 49:2, 112, 149, 177, 178, 179, 188, 254, 255, and 264 are suitably used. In particular, use of one or more selected from the group consisting of C.I. Pigment Red 264 (PR264), C.I. Pigment Red 177 (PR177), and C.I. Pigment Red 179 (PR179) is preferred. Addition of a red ink composition can provide images having a better hue.

The concentration of the solid content of a pigment in a red ink composition used for an ink set according to the present invention is not particularly restricted. However, in view of achieving appropriate color reproduction in recorded images, the concentration is preferably 6 wt % or more.

Alcohol solvents, a surfactant, a dispersing agent, water, other components, and the like as in the yellow ink composition can also be added to the red ink composition.

### Ink Jet Recording Method

In an ink jet recording method according to the present invention, printing is conducted by ejecting droplets of the ink compositions described above and making the droplets adhere to recording media. In such a recording method according to the present invention, use of synthetic paper or coated printing paper as recording media is preferred. In particular, images of high quality free from white streaks and roughness can be provided even when the images are printed at a low resolution on art paper, high quality paper for POD (print on demand) applications, or special paper for laser printers. An example of coated printing paper such as art paper is OK Topkote Plus (manufactured by Oji Paper Co., Ltd.). An example of high quality paper having suitability for an ink jet and a texture similar to that of coated printing paper and used for POD applications is Ricoh business coat gloss 100 (manufactured by Ricoh Company, Ltd.). An example of special paper for laser printers is LPCCTA4 (manufactured by SEIKO EPSON CORPORATION). Such papers have a better capability of absorbing ink in terms of speed in the following ascending order: coated printing paper, paper for POD applications, and special paper for laser printers.

### EXAMPLES

Hereinafter, the present invention is described in further detail with reference to examples. However, the present invention is not restricted to these examples.

### Example 1

An ink set was provided by preparing a magenta ink composition, a yellow ink composition, a cyan ink composition, and a black ink composition that had compositions below. The styrene-acrylic-acid-based resins in the compositions below were copolymers having a molecular weight of 1600 and an acid value of 150. The fluorene-based resins contained a monomer having a fluorene structure designated by CAS No. 117344-32-8 in a monomeric proportion of about 50 wt % and had a molecular weight of 3300. The oxyethyl acrylate-based resin contained a monomer having an oxyethyl acrylate structure designated by CAS No. 72009-86-0 in a monomeric proportion of about 75 wt % and had a molecular weight of 6900. The surfactants used were organopolysiloxane-based surfactants that were mixtures of a compound represented by Formula (I) above where R represents a methyl group, a represents an integer of 9 to 13, m represents an integer of 2 to 4, and n represents an integer of 1 to 2; and a compound represented by Formula (I) above where R represents a hydrogen atom, a represents an integer of 7 to 11, m represents an integer of 30 to 50, and n represents an integer of 3 to 5.

### <Magenta Ink Composition 1>

| Glycerin | 5.0 | wt % |
|---|---|---|
| 1,2-hexanediol | 1.0 | wt % |
| 1,2-octanediol | 2.0 | wt % |
| 3-methyl-1,3-butanediol | 6.0 | wt % |
| Surfactant | 0.3 | wt % |
| Oxyethyl acrylate-based resin | 1.2 | wt % |
| Fluorene-based resin | 1.2 | wt % |
| Solid solution between C.I. Pigment Red 202 and | 6.0 | wt % |
| γ-type C.I. Pigment Violet 19 | | |
| Pure water | Remainder | |
| Total: | 100.0 | wt % |

### <Yellow Ink Composition 1>

| Glycerin | 5.0 | wt % |
|---|---|---|
| 1,2-hexanediol | 1.0 | wt % |
| 1,2-octanediol | 2.0 | wt % |
| 1,2,6-hexanetriol | 6.0 | wt % |
| Surfactant | 0.3 | wt % |
| Styrene-acrylic-acid-based resin | 1.2 | wt % |
| Fluorene-based resin | 1.2 | wt % |
| C.I. Pigment Yellow 74 | 6.0 | wt % |
| Pure water | Remainder | |
| Total: | 100.0 | wt % |

### <Cyan Ink Composition 1>

| Glycerin | 5.0 | wt % |
|---|---|---|
| 1,2-hexanediol | 1.0 | wt % |
| 1,2-octanediol | 3.0 | wt % |
| 1,2,6-hexanetriol | 3.0 | wt % |
| 3-methyl-1,3-butanediol | 3.0 | wt % |
| Surfactant | 0.3 | wt % |
| Styrene-acrylic-acid-based resin | 1.2 | wt % |
| Fluorene-based resin | 1.2 | wt % |
| C.I. Pigment Blue 15:3 | 6.0 | wt % |
| Pure water | Remainder | |
| Total: | 100.0 | wt % |

### <Black Ink Composition 1>

| Glycerin | 5.0 | wt % |
|---|---|---|
| 1,2-hexanediol | 1.0 | wt % |
| 1,2-octanediol | 2.0 | wt % |
| 1,2,6-hexanetriol | 6.0 | wt % |
| Surfactant | 0.3 | wt % |
| Styrene-acrylic-acid-based resin | 1.2 | wt % |
| Fluorene-based resin | 1.2 | wt % |
| C.I. Pigment Black 7 | 6.0 | wt % |
| Pure water | Remainder | |
| Total: | 100.0 | wt % |

### Example 2

Yellow ink composition 2 was prepared that was different from Yellow ink composition 1 in use of a mixture of C.I. Pigment Yellow (PY) 74 and C.I. Pigment Yellow (PY) (PY74:PY129=3:1). An ink set was provided as in Example 1 except that Yellow ink composition 1 was replaced with Yellow ink composition 2.

### Example 3

An ink set was provided as in Example 1 except that five colors were used by addition of a red ink composition having the following composition.

### <Red Ink Composition>

| Glycerin | 5.0 | wt % |
|---|---|---|
| 1,2-hexanediol | 1.0 | wt % |
| 1,2-octanediol | 2.0 | wt % |
| 1,2,6-hexanetriol | 6.0 | wt % |
| Surfactant | 0.3 | wt % |
| Styrene-acrylic-acid-based resin | 2.0 | wt % |
| Fluorene-based resin | 2.0 | wt % |
| C.I. Pigment Red 179 | 6.0 | wt % |
| Pure water | Remainder | |
| Total: | 100.0 | wt % |

### Example 4

An ink set was provided as in Example 2 except that five colors were used by addition of Red ink composition described in Example 3.

### Comparative Example 1

Magenta ink composition 2 was prepared that was different from Magenta ink composition 1 in use of γ-type C.I. Pigment Violet 19. An ink set was provided as in Example 1 except that the magenta ink composition was replaced with Magenta ink composition 2.

### Comparative Example 2

An ink set was provided as in Example 1 except that the magenta ink composition was replaced with Magenta ink composition 2 and Yellow ink composition 1 was replaced with Yellow ink composition 2. The ink compositions constituting the ink sets according to Examples 1 to 4 and Comparative Examples 1 to 2 are shown in Table 1 below.

TABLE 1

| | Magenta | Yellow | | Black | |
|---|---|---|---|---|---|
| | ink | ink | | ink | |
| | compo- | compo- | Cyan ink | compo- | Red ink |
| | sition | sition | composition | sition | composition |
| Example 1 | 1 | 1 | 1 | 1 | None |
| Example 2 | 1 | 2 | 1 | 1 | None |
| Example 3 | 1 | 1 | 1 | 1 | 1 |
| Example 4 | 1 | 2 | 1 | 1 | 1 |
| Comparative | 2 | 1 | 1 | 1 | None |
| Example 1 | | | | | |
| Comparative | 2 | 2 | 1 | 1 | None |
| Example 2 | | | | | |

### Examples 5 to 8 and Comparative Examples 3 to 4

Example ink sets 5 to 8 and Comparative Example ink sets 3 to 4 were respectively prepared as with the above-described ink sets of Examples 1 to 4 and the above-described ink sets of Comparative Examples 1 to 2 except that 1,2,6-hexanetriol in the ink compositions was replaced with 3-methylpentane-1,3,5-triol.

### Examples 9 to 12 and Comparative Examples 5 to 6

Example ink sets 9 to 12 and Comparative Example ink sets 5 to 6 were respectively prepared as with the above-described ink sets of Examples 1 to 4 and the above-described ink sets of Comparative Examples 1 to 2 except that 3-methyl-1,3-butanediol in the ink compositions was replaced with dipropylene glycol.

### Evaluation of Color Reproducibility

An ink jet printer PX-G900 (manufactured by SEIKO EPSON CORPORATION) was charged with the ink sets of Examples 1 to or the ink sets of Comparative Examples 1 to 2, and an LUT (Look Up Table: density conversion reference table) was prepared with an identical ink weight limitation. After that, images with which maximum color reproduction can be determined were recorded on PX proofing paper (manufactured by SEIKO EPSON CORPORATION) at 14440×720 dpi. Thus, recorded products were obtained.

Magenta ink composition 1 described above was measured in terms of an L* value, an a* value, and a b* value. Specifically, the magenta ink composition was measured in terms of the L* value, the a* value, and the b* value, according to a CIE standard, these values being calculated on the basis of the visible absorption spectrum of the magenta ink composition with U3300 (manufactured by Hitachi, Ltd.) and the like by determining the transmittance of the magenta ink composition under conditions of a scanning speed of 600 nm/min, a measurement wavelength region of 380 to 800 nm, and a slit width of 2.0 nm, and calculating the values with a D65 light source and at an angle of view of 2°.

As a result, when the a* value according to a CIE standard, the value being calculated on the basis of a visible absorption spectrum, was 80 with an aqueous solution diluted with a dilution factor of 10,000 or less, the L* value was 65 and the b* value was −27.

Magenta ink composition 1 described above had an L* value, according to a CIE standard, of 96.5 with an aqueous solution having a concentration of the solid content of the pigment of 2×10-3 g/l, the value being calculated on the basis of a visible absorption spectrum.

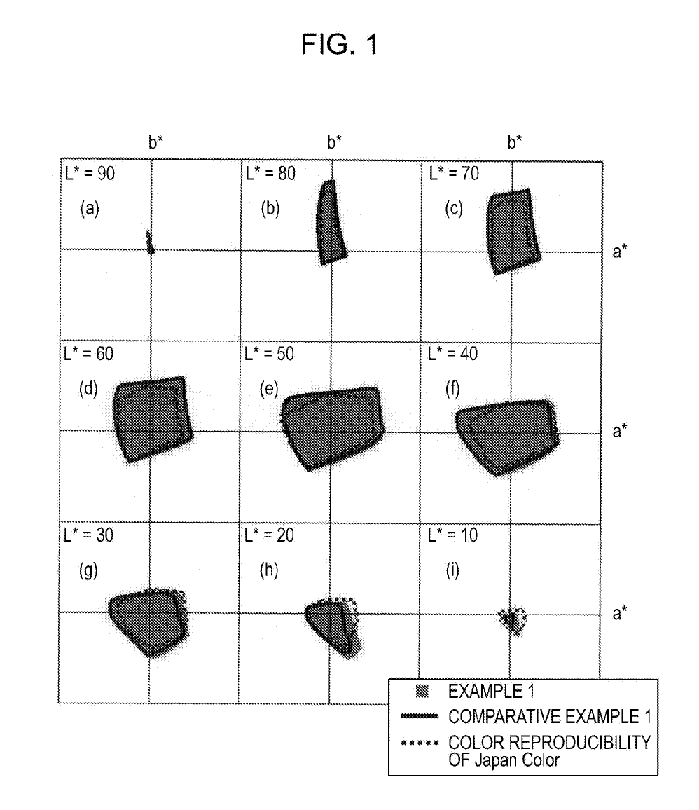

For Magenta ink composition 1 described above, when the L* value according to a CIE standard, the value being calculated on the basis of a visible absorption spectrum, was 94 with an aqueous solution diluted with a dilution factor of 10,000 or more, the a* value was −13 and the b* value was −6. The resultant recorded products are shown in FIGS. 1 to 6.

FIG. 1 shows comparison among color reproduction areas of the ink sets of Example 1 and Comparative Example 1 and patch patterns of color reproducibility of Japan Color. FIG. 1(a) shows comparison among color reproduction areas in a high lightness region (L* value=90). FIG. 1(b) shows comparison among color reproduction areas in a high lightness region (L* value=80). FIG. 1(c) shows comparison among color reproduction areas in a high lightness region (L* value=70). FIG. 1(d) shows comparison among color reproduction areas in a medium lightness region (L* value=60). FIG. 1(e) shows comparison among color reproduction areas in a medium lightness region (L* value=50). FIG. 1(f) shows comparison among color reproduction areas in a medium lightness region (L* value=40). FIG. 1(g) shows comparison among color reproduction areas in a low lightness region (L* value=30). FIG. 1(h) shows comparison among color reproduction areas in a low lightness region (L* value=20). FIG. 1(i) shows comparison among color reproduction areas in a low lightness region (L* value=10). Herein, the color reproducibility of Japan Color was obtained by computational processes as in Comparative Example and Example on the basis of values obtained by subjecting printed products of coated paper contained in “JSC 2007 Manual of Japan Color 2007 for Sheet-Fed Printing” showing printing color standards for sheet-fed offset printing defined by Standard Committee of The Japanese Society of Printing Science and Technology, Japan Printing Machinery Association, and Japan National Committee for ISO/TC130, to color measurement with a GretagMacbeth Spectrolino (D50 light source, angle of view of 2°, no UV filter) (manufactured by Gretag Corporation).

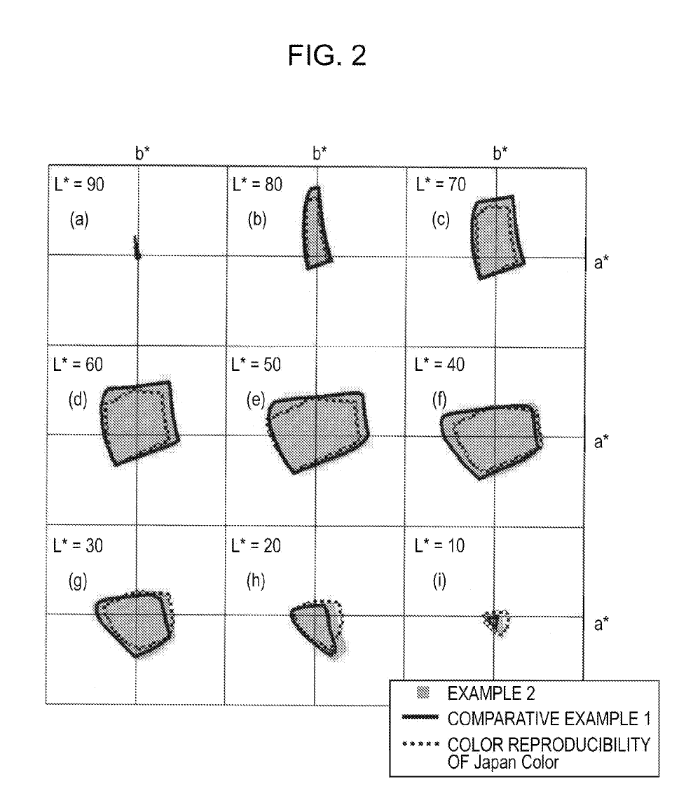

FIG. 2 shows comparison among color reproduction areas of the ink sets of Example 2 and Comparative Example 1 and patch patterns of color reproducibility of Japan Color. The L* values in FIG. 2 (a) to (i) are respectively the same as the L* values in FIG. 1 (a) to (i).

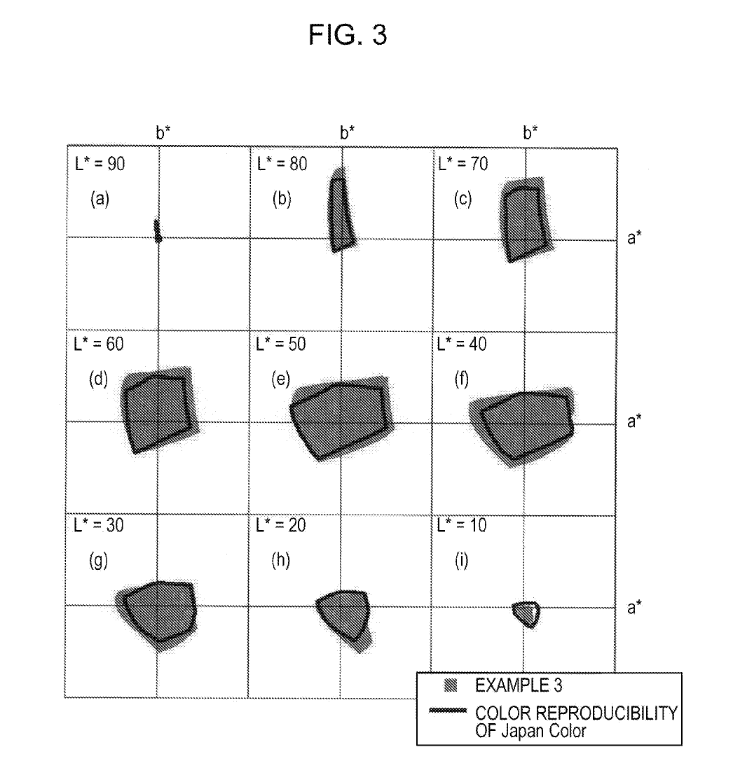

FIG. 3 shows comparison among color reproduction areas of the ink set of Example 3 and patch patterns of color reproducibility of Japan Color. The L* values in FIG. 3 (a) to (i) are respectively the same as the L* values in FIG. 1 (a) to (i).

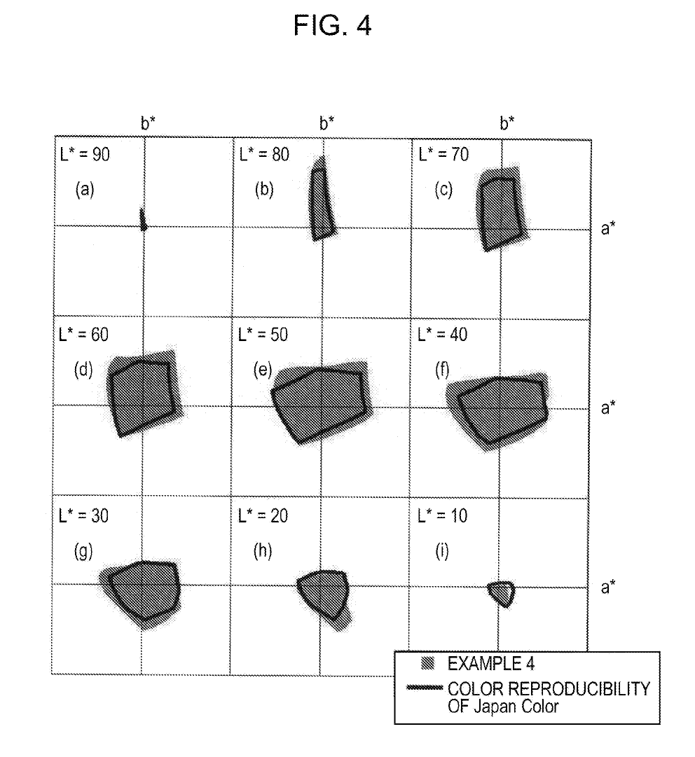

FIG. 4 shows comparison among color reproduction areas of the ink set of Example 4 and patch patterns of color reproducibility of Japan Color. The L* values in FIG. 4 (a) to (i) are respectively the same as the L* values in FIG. 1 (a) to (i).

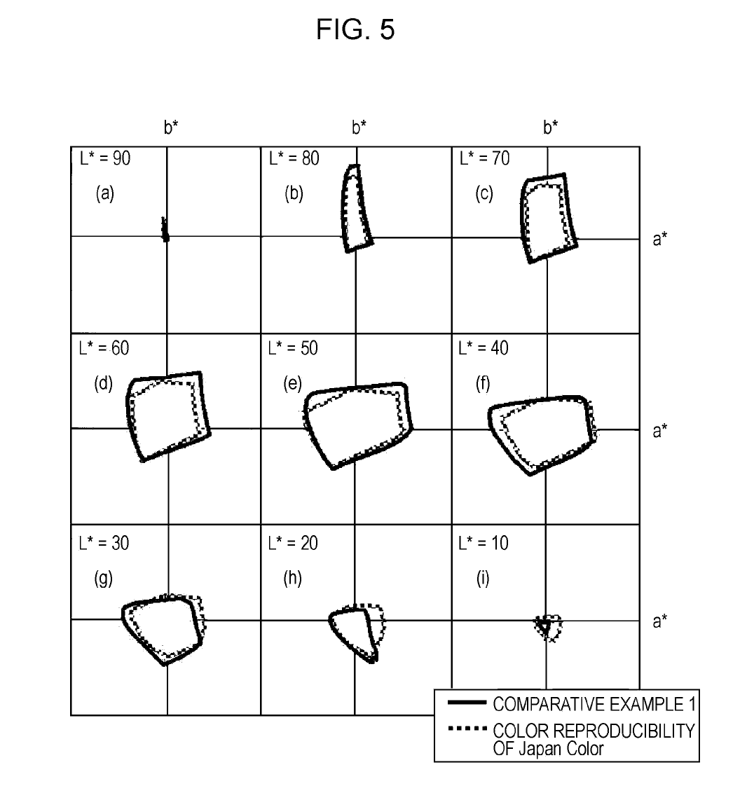

FIG. 5 shows comparison among color reproduction areas of the ink set of Comparative Example 1 and patch patterns of color reproducibility of Japan Color. The L* values in FIG. 5 (a) to (i) are respectively the same as the L* values in FIG. 1 (a) to (i).

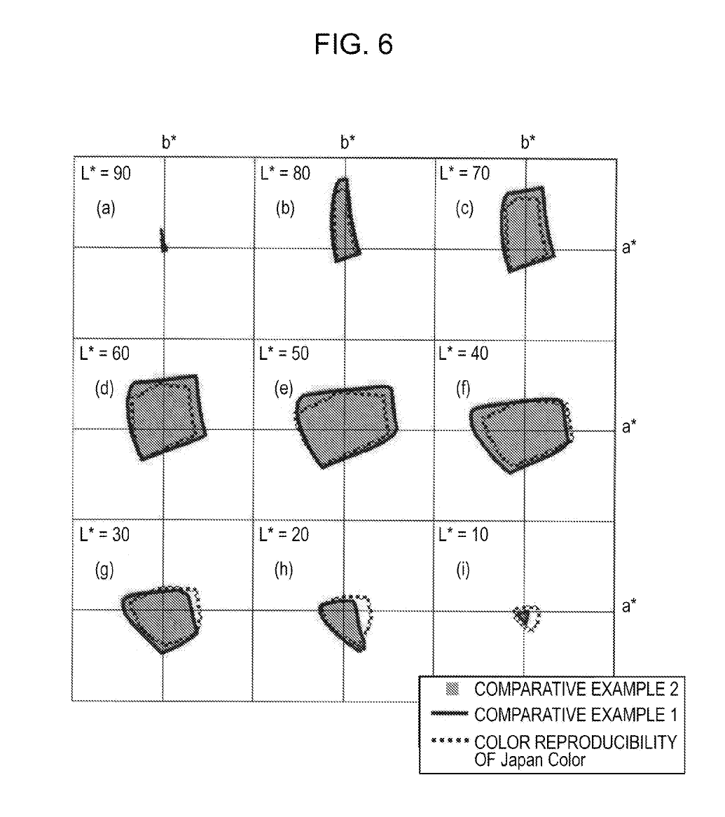

FIG. 6 shows comparison among color reproduction areas of the ink sets of Comparative Examples 2 and 1 and patch patterns of color reproducibility of Japan Color. The L* values in FIG. 6 (a) to (i) are respectively the same as the L* values in FIG. 1 (a) to (i).

Evaluation of color reproducibility was conducted by visually inspecting Color regions I to III of the resultant recorded products and observing whether color was reproduced or not in each color region. Herein, Color region I corresponds to a red region ranging from L*40 to L*10, Color region II corresponds to a yellow region ranging from L*80 to L*10, and Color region III corresponds to a blue region and a red region ranging from L*40 to L*20. The results are shown in Table 2 below.

AA: All Color regions I, II, and III can be color-reproduced.

A: Color regions I and III can be reproduced while Color region II cannot be reproduced.

B: Color regions I and II can be reproduced while Color region III cannot be reproduced.

C: Either Color region I or II can be reproduced while Color region III cannot be reproduced.

D: All Color regions I, II, and III cannot be color-reproduced.

TABLE 2

| Sample | Gamut volume | Evaluation of color reproducibility |
|---|---|---|
| Example 1 | 560,000 | C |
| Example 2 | 570,000 | B |
| Example 3 | 600,000 | A |
| Example 4 | 610,000 | AA |
| Comparative | 520,000 | D |
| Example 1 | | |
| Comparative | 530,000 | C |
| Example 2 | | |

The ink sets of Examples 5 to 8 and the ink sets of Comparative Examples 3 to 4 were also evaluated in the same manner as described above. As a result, the ink sets of Examples 5 to 8 had larger gamut volumes than those of the ink sets of Comparative Examples 3 to 4. These results were similar to those of the ink sets of Examples 1 to 4 and the ink sets of Comparative Examples 1 to 2.

The ink sets of Examples 9 to 12 and the ink sets of Comparative Examples 5 to 6 were also evaluated in the same manner as described above. As a result, the ink sets of Examples 9 to 12 had larger gamut volumes than those of the ink sets of Comparative Examples 5 to 6. These results were similar to those of the ink sets of Examples 1 to 4 and the ink sets of Comparative Examples 1 to 2.

What is claimed is:

1. An ink set at least comprising a yellow ink composition, a magenta ink composition, and a cyan ink composition,
wherein each ink composition at least contains a pigment, water, a water-soluble alcohol solvent, a slightly water-soluble alcohol solvent, and a surfactant; and the magenta ink composition contains, as the pigment, a solid solution between C.I. Pigment Red 202 and γ-type C.I. Pigment Violet 19.

2. The ink set according to claim 1, wherein a content ratio of the slightly water-soluble alcohol solvent to the water-soluble alcohol solvent is 1:1 to 1:6.

3. The ink set according to claim 1 or 2, wherein, in at least one of the ink compositions, a total content of the slightly water-soluble alcohol solvent and the water-soluble alcohol solvent is 11 wt % or less.

4. The ink set according to any one of claims 1 to 3, wherein, in at least one of the ink compositions, a content of the slightly water-soluble alcohol solvent is 1 to 3 wt %.

5. The ink set according to any one of claims 1 to 4, wherein, in at least one of the ink compositions, a content of the water-soluble alcohol solvent is 4 to 8 wt %.

6. The ink set according to any one of claims 1 to 5, wherein the slightly water-soluble alcohol solvent is an alkanediol.

7. The ink set according to any one of claims 1 to 6, wherein the slightly water-soluble alcohol solvent is 1,2-octanediol.

8. The ink set according to any one of claims 1 to 7, wherein the water-soluble alcohol solvent contains a water-soluble alkanediol and/or an alkylene glycol.

9. The ink set according to claim 8, wherein the water-soluble alkanediol contains a water-soluble alkanediol with a main chain including 4 to 6 carbon atoms.

10. The ink set according to claim 8, wherein the water-soluble alkanediol contains a 1,2-alkanediol that may optionally include a branched chain and a 1,3-alkanediol that may optionally include a branched chain.

11. The ink set according to any one of claims 8 to 10, wherein a content ratio of the water-soluble alkanediol to the alkylene glycol is 1:1 to 1:6.

12. The ink set according to any one of claims 8 to 11, further containing a water-soluble alkanetriol.

13. The ink set according to any one of claims 10 to 12, wherein the 1,2-alkanediol that may optionally include a branched chain is one or more selected from the group consisting of 1,2-hexanediol, 4-methyl-1,2-pentanediol, and 3,3-dimethyl-1,2-butanediol.

14. The ink set according to any one of claims 10 to 13, wherein the 1,3-alkanediol that may optionally include a branched chain is 3-methyl-1,3-butanediol.

15. The ink set according to any one of claims 8 to 14, wherein the alkylene glycol is dipropylene glycol.

16. The ink set according to any one of claims 12 to 15, wherein the water-soluble alkanetriol is one or two selected from the group consisting of 1,2,6-hexanetriol and 3-methylpentane-1,3,5-triol.

17. The ink set according to any one of claims 1 to 16, wherein the surfactant is contained in an amount of 0.01 to 1.0 wt % based on the ink compositions.

18. The ink set according to claim 17, wherein the surfactant is a polyorganosiloxane-based surfactant.

19. The ink set according to any one of claims 1 to 18, wherein at least one of the ink compositions contains a dispersing agent permitting dispersion of the pigment in ink.

20. The ink set according to claim 19, wherein the dispersing agent contains at least one resin selected from styrene-acrylic-acid-based copolymer resins, urethane-based resins, fluorene-based resins, and oxyethyl acrylate-based resins.

21. An ink jet recording method comprising ejecting droplets of ink compositions so that the droplets adhere to a recording medium to conduct printing, wherein the ink compositions are the ink compositions of the ink set according to any one of claims 1 to 20.

22. The method according to claim 21, wherein the recording medium is synthetic paper mainly composed of a synthetic resin or coated printing paper.

23. An ink cartridge integrally or independently containing at least one or more of the ink compositions of the ink set according to any one of claims 1 to 20.
